(19) United States
(12) Patent Application Publication
(10) Pub. No.: US 2009/0252151 A1
(43) Pub. Date: Oct. 8, 2009

(54) Method and Network Elements for Content Duplication in Packet Networks

(76) Inventor: Pieter Rappe, Lichtaart (BE)

Correspondence Address: STAAS & HALSEY LLP, SUITE 700, 1201 NEW YORK AVENUE, N.W., WASHINGTON, DC, 20005, US

(21) Appl. No.: 12/084,104

(22) PCT Filed: Oct. 4, 2006
(86) PCT No.: PCT/EP2006/067019

§ 371 Date: Apr. 25, 2008

(30) Foreign Application Priority Data
Oct. 25, 2005 (EP) EP05023265

(51) Int. Cl. H04L 12/66

(52) U.S. Cl. 370/352

(57) ABSTRACT

There is provided method for duplicating communications content in a telecommunications network, wherein the content is transported in a layered communications protocol comprising at least one protocol layer. The method comprises receiving first data identifying the content to be duplicated, receiving second data identifying a lowest protocol layers to be duplicated, and duplicating the content as identified by said first data including all protocol information of the lowest protocol layer as identified by said second data, further including all higher layer protocol information. An advantage thereof is that, by means of the second data, the protocol depth of the duplication may be influenced. For example, if the content is transported by the protocols RTP (real-time protocol), UDP (user datagram protocol), and IP (internet protocol), then by means of the second data the content alone, or the content plus the entire RTP protocol information (of which the content is the payload), or the entire IP traffice associated with the content to be duplicated could be selected for duplication. A preferred application of the duplication method is lawful interception (LI), wherein the duplicated content and protocol information along with labels and/or parameters, if applicable, is forwarded to a monitoring facility or monitoring center.

### CROSS REFERENCE TO RELATED APPLICATIONS

This application is based on and hereby claims priority to European Application No. EP05023265 filed on Oct. 25, 2005 and PCT Application No. PCT/EP2006/067019 filed on Oct. 4, 2006, the contents of which are hereby incorporated by reference.

### BACKGROUND

Lawful interception (LI) is the legally sanctioned official access to communications, such as telephone calls or e-mail messages, of a user under surveillance. In general, LI is a security process in which a network operator or service provider gives law enforcement officials access to the communications of private individuals or organizations. Country-specific laws regulate lawful interception procedures around the world.

A LI warrant may grant the authority to record the actual communications contents. To ensure that the observation results are, for example, admissible as evidence in a court of law, it is imperative that they are properly labeled during the recording process. Labeling may include the (coded) identity of the observed user, date and time of the recording, a unique identification of the recorded communications, and other information. Standardization organizations such as ETSI and 3GPP have created, or are in the process of defining, standards to facilitate the economic realization of lawful interception that complies with the national and international conventions and legislation.

In circuit switched telecommunications networks, the telephone exchange is the network element where the communication content is duplicated. The original connection is normally not affected, and a copy of the—usually bidirectional—communication content is passed to a monitoring facility or monitoring center for recording.

As telecommunications networks evolve from circuit switched to packet network based, and particularly to Internet Protocol (IP) based, traditional LI schemes developed for intercepting circuit switched communications are replaced by LI schemes that better address the packet based network infrastructures and their multimedia capabilities. In IP based telecommunications networks, there usually is a functional and physical separation between the bearer control entity and the call control entity. The bearer control entity is often also referred to as the Media Gateway (MG), and the call control entity often comprises a Media Gateway Controller (MGC). A gateway control protocol such as ITU-T H.248 or IETF MeGaCo is used for communication between the MGC and the MG.

The network element performing the duplication of communications content in an IP environment is often called Interception Access Point (IAP). A variety of network elements may serve as IAP for a given interception, including but not limited to a MG, an access gateway, or a media server. In general, any device controllable by a gateway control protocol may serve as IAP.

Gateway control protocols H.248 and Megaco, as currently implemented, enable the call control entity to instruct an IAP to create and forward a copy of a call content or communications content to the monitoring facility or center. With either protocol, however, only this basic interception function of creating and forwarding a copy of the actual communications contents is available. Disadvantageously, the monitoring center cannot flexibly be provided with advanced interception data and/or proper labeling of the intercepted call.

### SUMMARY

It is therefore one potential object to provide a novel method for content duplication in a telecommunications network. It is another potential object to provide an improved content duplication node for a telecommunications network. It is yet another potential object to provide an improved call control entity for a telecommunications network.

The inventor proposes a method for duplicating communications content in a telecommunications network, wherein the content is transported in a layered communications protocol comprising at least one protocol layer, the method comprising the steps of:
receiving first data identifying the content to be duplicated;
receiving second data identifying a lowest protocol layers to be duplicated; and
duplicating the content as identified by said first data including all protocol information of the lowest protocol layer as identified by said second data, further including all higher layer protocol information.

An advantage thereof is that, by the second data, the protocol depth of the duplication may be influenced. For example, if the content is transported by the protocols RTP (real-time protocol), UDP (user datagram protocol), and IP (internet protocol), then by the second data the content alone, or the content plus the entire RTP protocol information (of which the content is the payload), or the entire IP traffic associated with the content to be duplicated could be selected for duplication.

A preferred application of the duplication method is lawful interception (LI), wherein the duplicated content and protocol information along with labels and/or parameters, if applicable, is forwarded to a monitoring facility or monitoring center.

The inventor also proposes a content duplication node, such as a MG or access gateway, configured for implementing the proposed method.

The inventor also proposes a call control entity such as a MGC for supplying, using the control protocol, information and/or instructions to a content duplication node in order to control the method

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows one potential embodiment of a network configuration for deploying the proposed method;

FIG. 2 shows duplication or interception of communication content at various protocol levels;

FIG. 3 shows a functional overview of a lawful intercept configuration; and

FIG. 4 shows auxiliary intercept information that may be forwarded in conjunction with the communication content for various intercept configurations.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

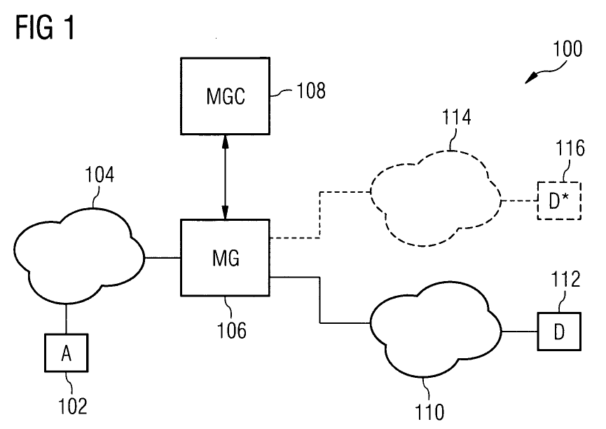

In FIG. 1, there is shown an exemplary network configuration 100 comprising a user terminal 102 connected via a first network section 104, a media gateway (MG) 106, and a second network section 110 to a destination 112. MG 106 is controlled by a media gateway controller (MGC) 108 in accordance with any (media) gateway control protocol such as H.248 and Megaco. In the MG 106, content is duplicated and forwarded via a third network section 114 to a duplication destination 116 (shown with dashed lines).

MG 106 performs the duplication of the communication content to and from user terminal 102 under the control of MGC 108, which in turn may be controlled by some other network entity (not shown). It shall be noted that, with reference to the terminal's communication relation, MGC 108 acts as a call control entity (CCE), whereas MG 106 acts as a content duplication node.

Existing (media) gateway control protocols such as H.248 and Megaco allow the CCE to instruct the content duplication node to forward the actual call contents or communications contents to the duplication destination 116. Existing gateway control protocols, however, do not allow for the CCE to instruct the content duplication node to include protocol information of those protocols in which the call content is embedded. In other words, with existing gateway control protocols, the protocol overhead is stripped from the communication contents and therefore lost at the duplication destination 116.

Protocol extensions are provided allowing the CCE to instruct the content duplication node to include any protocol level or layer below the actual communication content, i.e., any “overhead” necessary for conveying the voice or data in the communications network.

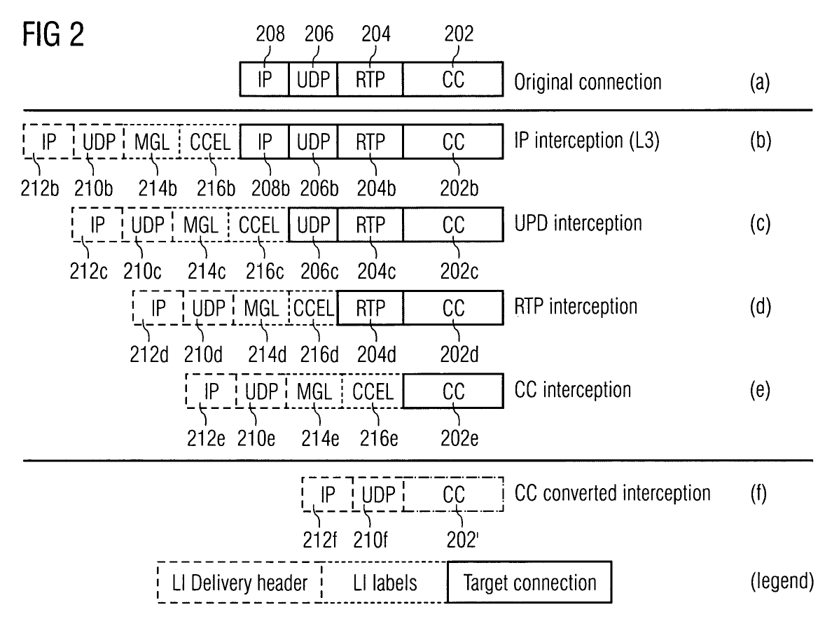

This procedure is illustrated with reference to FIG. 2 using a typical Voice over IP (VoIP) communication content stream as an example. In FIG. 2(a), there is schematically shown the original connection data comprising call content (CC) 202, real-time protocol (RTP) protocol information 204, user datagram protocol (UDP) protocol information 206, and internet protocol (IP) protocol information 208. It shall be noted that “protocol information” may refer to any protocol information such as headers, trailers, packet counters, payload identifiers, priority indicators, parameters, labels, and other information included to allow communication at the respective protocol layer in conformance with the respective national or international standard(s).

When instructed by the CCE (in the example of FIG. 1: MGC 108), the content duplication node (in the example of FIG. 1: MG 106) may duplicate the entire IP packet comprising the UDP datagram, in turn comprising the RTP packet, in turn comprising the actual communication content CC (which may be encoded voice or data), as shown in FIG. 2(b). To that end, MGC 108 instructs MG 106 by first data as to which terminal equipment's content is to be duplicated, and by second data that IP level duplication is required, whereupon MG 106 duplicates the communication content associated with terminal equipment 102 including IP protocol information and all higher protocol layers' protocol information.

The duplicated content 202b . . . 208b may be encapsulated in a transport protocol in accordance with the duplication destination's capabilities. In the example of FIG. 2(b)-(f), the duplicated content is sent in the form of UDP datagrams over IP to duplication destination 116. The protocol information necessary for this encapsulation is schematically shown as IP delivery protocol information 212b and UDP delivery protocol information 210b. In the schematic of FIG. 2 (b)-(f), this delivery protocol information is shown within dashed lines.

MG 106 may also be instructed by MGC 108 to include labels or other parameters, either received from the MGC 108 and transparently inserted into the data stream to duplication destination 116 as call control entity labels (CCEL) 216b, or created by the MG 106 and inserted into the data stream to duplication destination 116 as media gateway labels (MGL) 214b. These labels or parameters, CCEL and MGL, will be discussed in detail further below and are shown in FIG. 2(b)-(e) within dotted lines.

Third data may be provided to the MG 106 specifying, for each protocol layer to be duplicated in accordance with the second data, the amount of detail to be duplicated. For example, certain protocol information included in the original connection's content stream 202 . . . 208 may serve to mitigate the effect of transmission errors, for example by including a redundancy coding scheme. It may, however, not be desirable to receive such protocol information at the duplication destination 116, as for example the third network section 114 may employ its own error correction scheme, rendering any other error correction schemes meaningless. In other embodiments, the amount of detail to be duplicated will be reduced in accordance with the third data to save bandwidth in the third network section 114 through which the duplicated information traverses.

The CCE (e.g., MGC 108) may also instruct the content duplication node (e.g., MG 106) to create the following duplicates:
all information 202c . . . 206c above the IP layer, i.e., the protocol information of the UDP layer and all higher layers, as shown in FIG. 2(c); or
all protocol information 202d . . . 204d of the RTP layer and all higher layers, as shown in FIG. 2(d); or
the call content or connection content 202e only, as shown in FIG. 2(e).

As before, this is achieved by MGC 108 instructing MG 106 by first data as to which terminal equipment's content is to be duplicated, and by second data what level's duplication is required (UDP, RTP, CC), whereupon MG 106 duplicates the communication content associated with the references terminal equipment 102 including UDP, RTP protocol information and all higher protocol layers' protocol information, respectively.

The duplicated content may again be encapsulated in a transport protocol in accordance with the duplication destination's capabilities, as described with more details with reference to FIG. 2(b) above. As before, MG 106 may optionally be instructed by MGC 108 to include labels or other parameters, either received from MGC 108 and transparently inserted into the data stream to duplication destination 116 as call control entity labels (CCEL) 216c . . . e, or created by MG 106 and inserted into the data stream to duplication destination 116 as media gateway labels (MGL) 214c . . . e.

It shall be noted that it may be desirable or even necessary to convert the communication content or call content before forwarding the duplicated content to duplication destination 216, for example if the communication is a voice call using a codec not supported by duplication destination 216. In such cases, MG 106 may optionally transcode the call content to a more favorable format. Modification or transcoding of communication content may also be applied to encrypted communications. Forwarding transcoded or otherwise converted communication content is schematically shown FIG. 2(f). It shall be noted that content transcoding or conversion may of course be applied in conjunction with any of the different layers of protocol information duplication as described with reference to FIG. 2(b)-(e) above.

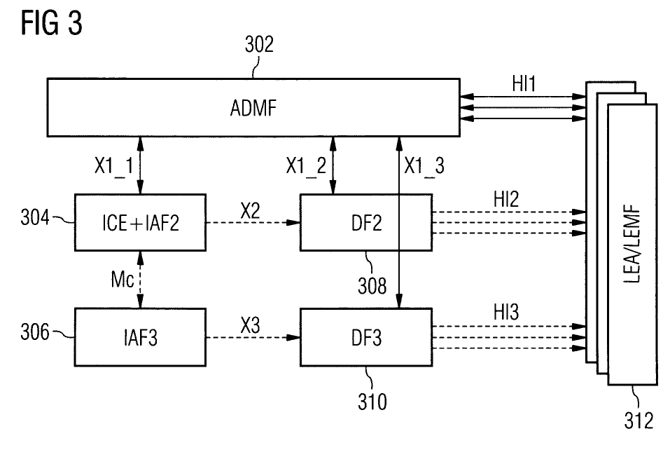

As indicated above, the proposed method may preferentially be embodied in a lawful interception implementation. FIG. 3 shows a functional overview of an exemplary lawful intercept configuration comprising an administration function (ADMF) 302; an interception control element (ICE) 304, which has an interception access function 2 (IAF2); and an element 306 having an interception access function 3 (IAF3). The LI configuration of FIG. 3 further comprises delivery functions (DF2 and DF3) 308, 310; and a law enforcement monitoring function (LEMF) 312, usually located at a law enforcement agency (LEA). A more detailed description of the elements, interfaces X1_1, X1_2, X1_3, X2, X3, Mc, and handover interfaces HI1 . . . 3, as shown in FIG. 3, can be found in 3GPP TS 33.107. In general, the actual call content is delivered to LEMF 312 via DF3 310, while intercept related information (IRI) is delivered via DF2 308.

Applying the functional structure presented in FIG. 3 to the exemplary network configuration of FIG. 1, the call control element, or MGC 108, would act as ICE 304 with reference to terminal 102. The content duplication node, or MG 106, would act as IAF3 306 with reference to terminal 102. The content duplication node is sometimes also referred to as interception access point (IAP) in a LI context. Third network section 114 and duplication destination 116, as shown in FIG. 1, schematically represent the delivery functions 308, 310 and the LEMF 312 of FIG. 3. In operation, the ADMF 302 exercises control over the intercept by controlling MGC 108 which in turn controls MG 106 accordingly.

As explained generally with reference to content duplication above, the lawful interception information received at the LEMF 312 may comprise the following information:
the actual call content accompanied by all protocol information of a desired level of protocol depth, for example all information contained in the OSI network layer or in the internet layer, or any subset thereof;
labels, parameters, and other information passed from the ICE to the IAP for inclusion in the information sent to the LEMF 312; such labels or parameters may comprise a target identification, a connection identification, and/or an intercepting control identity; and/or
labels, parameters, and other information created by the IAP for inclusion in the information sent to the LEMF 312; such labels or parameters may comprise a duplication timestamp; a duplication node identifier or IAP identifier; direction information on intercepted packets; or a packet counter.

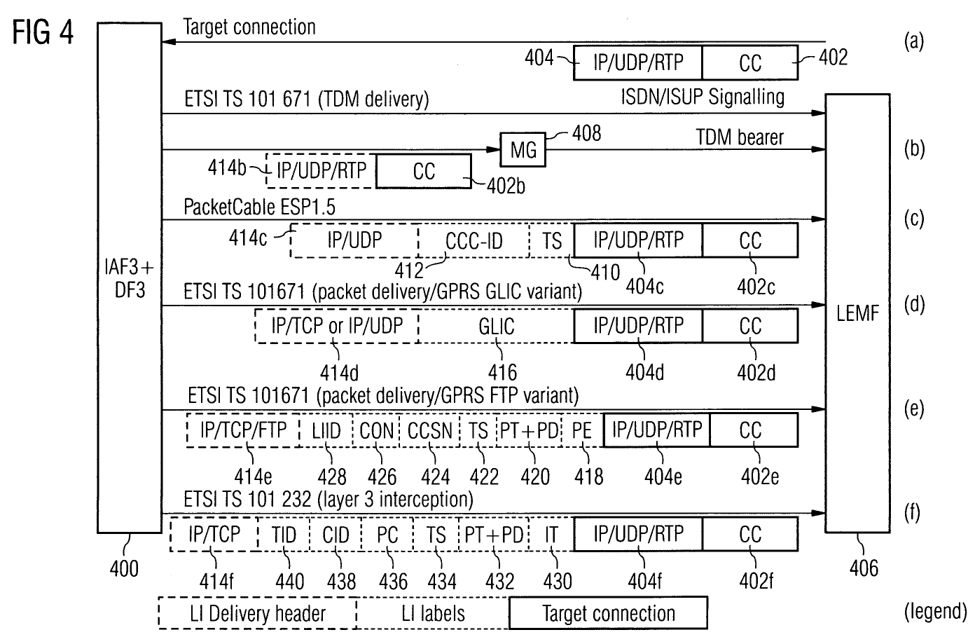

Further details on the information that optionally may be included in the LI information towards LEMF 312 will now be explained with reference to five exemplary modes of delivery of intercepted information shown in FIG. 4. Such information may, for example, be included by the IAP or the delivery function 3 (DF3). For purposes of explanation, communication content 402 is again assumed to be encapsulated in the RTP/UDP/IP layered communication protocols 404. Communication content may generally be encapsulated in any other known protocol hierarchy, as will be readily apparent to those with skills in the art.

In a first mode of delivery of intercepted information from an intercept access point or function 400, which in FIG. 4 is shown to also comprise the delivery function DF3, delivery to LEMF 406 is accomplished by TDM as specified in ETSI TS 101 671, as shown in FIG. 4(b). The duplicated call content 402b cannot be transferred to the TDM port of LEMF 406 without conversion. Such conversion can be accomplished in the IAF 400 or by a separate media gateway 408 which may then be addressed by protocol headers 414b. In such conversion, all other information such as protocol information 404, labels, or parameters, is lost and therefore needs to be included in the ISDN or ISUP signaling using any known method such as user-to-user signaling (UUS) or proprietary signaling protocols over the signaling channel. In general, all protocol information, labels and/or parameters discussed herein may be transported in a suitable protocol container using TDM signaling.

With reference to FIG. 4(c), there is shown a second mode of delivery of intercepted information particularly useful for performing LI in conformance with PacketCable Electronic Surveillance Specification ESP1.5.The IAF duplicates call content 402c and the desired level of protocol information 404c in accordance with the procedures explained above with reference to FIG. 2, and adds protocol information 414c for communicating with LEMF 406 such as UDP/IP headers. The IAF may further include a call content connection (CCC) ID 412 as a unique identifier per target and connection, preferably created by a corresponding ICE such as MGC 108, and a time stamp (TS) 410, preferably created by IAF 400.

With reference to FIG. 4(d), there is shown a third mode of delivery of intercepted information particularly useful for performing LI in conformance with ETSI TS 101 671 GPRS LI Correlation (GLIC). The IAF duplicates call content 402d and the desired level of protocol information 404d in accordance with the procedures explained above with reference to FIG. 2, and adds protocol information 414d for communicating with LEMF 406 such as UDP/IP or TCP/IP headers. The IAF may further include GLIC information 416 which may comprise a gateway GPRS support node (GGSN) ID, a sequence number or packet counter, and a packet direction, preferably created by IAF 400.

With reference to FIG. 4(e), there is shown a fourth mode of delivery of intercepted information particularly useful for performing LI in conformance with ETSI TS 101 671 GPRS FTP variant. The IAF duplicates call content 402e and the desired level of protocol information 404e in accordance with the procedures explained above with reference to FIG. 2, and adds protocol information 414e for communicating with LEMF 406 such as FTP/TCP/IP headers. The IAF may further include the following information in the data packets transmitted to the LEMF 406:
a LI target identifier (LIID) 428;
a correlation number (CON) 426 which may comprise a GGSN-ID and a charging ID;
a packet counter or communication content sequence number (CCSN) 424;
a time stamp (TS) 422;
a parameter 420 identifying payload direction (PD) and payload type (PT); and/or
a private extension (PE) field 418.

Finally, with reference to FIG. 4(f), there is shown a fifth mode of delivery of intercepted information particularly useful for performing LI in conformance with ETSI TS 101 232 for layer 3 interception. The IAF duplicates call content 402f and the desired level of protocol information 404f in accordance with the procedures explained above with reference to FIG. 2, and adds protocol information 414f for communicating with LEMF 406 such as TCP/IP headers. The IAF may further include the following information in the data packets transmitted to the LEMF 406:
a target identifier (TID) 440 which may comprise an authorization country code (ACC) and a LIID;
a communication ID (CID) 438 which may comprise an operator ID (OPID), a network element ID (NEID), a communication ID number (CIN) and a delivery country code (DCC);
a packet counter (PC) 436;
a time stamp (TS) 434;
a parameter 432 identifying payload direction (PD) and payload type (PT); and/or
an interception type (IT) 430.

Generally, information elements, parameters, or labels such as information elements, parameters, or labels 410, 412, 416, 418 . . . 440 are created by either the call controlling entity such as a MGC or the IAP such as a MG as follows: Statically engineered information and information determined on a per-call basis is preferably generated by the controlling entity and forwarded to the IAP which then transparently includes this information in the data stream sent to LEMF 406. Run-time information such as timestamps 410, 422, 434 or packet counters 436, 424 is preferentially created upon instruction from the controlling entity by the IAP, or IAF, and then forwarded to the LEMF.

Information elements, parameters, or labels such as information elements, parameters, or labels 410, 412, 416, 418 . . . 440 may be forwarded under the H.248 protocol for example within the Topology Descriptor, Termination State Descriptor, Stream Descriptor, and/or Package Descriptor. Instructions from a MGC to a MG may also be forwarded under the H.248 protocol for example within the Topology Descriptor, Termination State Descriptor, Stream Descriptor, and/or Package Descriptor. In more detail, exemplary H.248 instructions from MGC to MG may have the following format:
Topology (Ts, Td, Topology, [Stream], [Level]), wherein Ts is the source termination, Td is the destination termination, and [Level] is the second data;
(Ts, Td, Oneway, ′″, “L3”) for level 3 (e.g., IP level) interception of incoming streams at Ts;
(Ts, Td, Onewayexternal, ′″, “CC”) for call content level interception of outgoing streams at Ts; and/or
(Ts, Td, Oneway), wherein the omitted second data results in a default (predefined or preset) behavior such as CC level interception.

It shall be noted that the proposed method can be applied if the intercept strategy is a real-time strategy prioritizing the real-time availability of the intercepted information, e.g., for

1-16. (canceled)

17. A method for duplicating communications content in a telecommunications network, wherein the content is transported in a layered communications protocol having protocol layers, the method comprising:
receiving first data identifying the content to be duplicated;
receiving second data identifying a lowest protocol layer to be duplicated; and
duplicating the content as identified by said first data to thereby produce duplicate content;
duplicating all protocol information of the lowest protocol layer as identified by said second data; and
duplicating all protocol information associated with each protocol layer above the lowest protocol layer.

18. The method of claim 17, further comprising:
receiving third data identifying the amount of protocol information to be duplicated for the lowest protocol layer identified by the second data and each protocol layer above the lowest layer.

19. The method of claim 17, wherein if the second data is missing or inconclusive, a preset protocol layer is used as the lowest protocol layer.

20. The method of claim 17, further comprising:
receiving instructions relating to labels or parameters to be created and added to the duplicate content; and
creating and adding labels or parameters to the duplicate content in accordance with said instructions.

21. The method of claim 17, further comprising:
receiving labels or parameters to be added to the duplicate content; and
adding the received labels or parameters to the duplicate content.

22. The method of claim 17, wherein:
the content to be duplicated is a packet or a stream of packets from a call, and
the layered communications protocol includes RTP, UDP, and IP protocol layers.

23. The method of claim 20, wherein the labels or parameters specified by the instructions comprise at least one of:
a duplication time stamp;
an identity of a duplication node;
a direction information representing a direction of an intercepted piece of content; and
a packet counter.

24. The method of claim 21, wherein the labels or parameters received comprise at least one of:
a target identification;
a connection identification; and
an intercepting control identity.

25. The method of claim 17, further comprising forwarding the duplicate content and protocol information to an intercept access point or a monitoring center of a law enforcement agency.

26. A content duplication node for a telecommunications network that uses a layered communications protocol having protocol layers, comprising:
a receiver to receive first data identifying a communications content to be duplicated and to receive second data identifying a lowest protocol layer to be duplicated;
a first duplication unit to duplicate the content as identified by said first data to thereby produce duplicate content; and
a second duplication unit to duplicate all protocol information of the lowest protocol layer as identified by said second data and all protocol information associated with each protocol layer above the lowest protocol layer.

27. A call control entity for a telecommunications network that uses a layered communications protocol having protocol layers, comprising:
a first instruction unit generate first instructions for a content duplication node, the first instructions requesting duplicate content and identifying a communications content to be duplicated; and
a second instruction unit to generate second instructions, the second instructions identifying a lowest protocol layer of the layered communications protocol and instructing the content duplication node to duplicate protocol information of the lowest protocol layer and protocol information associated with all protocol layers above the lowest protocol layer.

28. The call control entity of claim 11, further comprising a third instruction unit to create and sent third instructions relating to labels or parameters to be created and added to the duplicate content, the third instructions being sent to the content duplication node.

29. The call control entity of claim 28, wherein the third instructions request creation and addition of the following labels or parameters:
a duplication time stamp;
an identity of a duplication node;
a direction information representing a direction of an intercepted piece of content; and/or
a packet counter.

30. The call control entity of claim 27, further comprising a label unit to create labels or parameters to be added to the duplicate content and to send said labels or parameters to the content duplication node and instruct the content duplication node to add said labels or parameters to the duplicate content.

31. The call control entity of claim 30 wherein the label unit creates and sends at least one of the following labels or parameters:
a target identification;
a connection identification; and
an intercepting control identity.

32. The call control entity of claim 27, wherein the first and second instruction units operate according to a gateway control protocol.
